(19) United States
(12) Patent Application Publication
(10) Pub. No.: US 2005/0251731 A1
(43) Pub. Date: Nov. 10, 2005

(54) Video slide based presentations

(76) Inventors: Harold Michael Valderas, Austin, TX (US); Christopher Thomas Rebstock, Austin, TX (US)

Correspondence Address: LALLY & LALLY LLP, PO BOX 684749, AUSTIN, TX, 78768-4749, US

(21) Appl. No.: 11/069,710

(22) Filed: Mar. 1, 2005

Related U.S. Application Data
(60) Provisional application No. 60/567,603, filed on May 3, 2004.

(51) Int. Cl. G11B 7/00

(52) U.S. Cl. 715/500

(57) ABSTRACT

A system and program product for creating a presentation includes code enabling a user to create a navigable and linked set of video slide objects. A video slide object includes a looping video background, a text overlay, and possibly appended static or motion graphic elements. The text is preferably achieved using an overlay to a video slide. Code for editing the linked set of objects includes code for inserting a video slide into the linked set, altering an ordering of the video slides in the linked set, and deleting a video slide from the linked set. Code for automatically relinking the set of video slides to reflect a user edit is also included. The looping videos are preferably short, looping videos having a duration of less than approximately 1 minute. The looping videos preferably have seamless looping backgrounds and may be compatible with a prevalent multimedia protocol such as DVD.

This application claims priority from provisional application No. 60/567,603 filed 03 MAY 2004, which is incorporated in its entirety herein.

### BACKGROUND

1. Field of the Present Invention

The invention is in the field of computer software and, more specifically, computer software for creating presentation graphics.

2. History of Related Art

Presentation applications such as POWERPOINT® from Microsoft are pervasive and well known. Presentation applications enable a user to create visually appealing business presentations based on a series of slides that may or may not include text. Each slide may be thought of as a graphical image. In the vast majority of cases, the images are static, with some limited ability to incorporate motion graphics on individual slides. While conventional presentation applications have served an extensive need for a considerable period of time, the slide-based paradigm of these applications has become antiquated. Simultaneously, in fields such as broadcast journalism, dynamic and stimulating graphics have become the standard and, in the field of consumer and entertainment electronics, multimedia technologies such as DVD have flourished.

Projections estimate the number of DVD players in use by 2006 at over 420 million, one third of which are projected to reside in personal computers. DVD is a versatile medium that can be played from personal computers, laptops, set-top players, or small portable DVD players. While DVD has emerged as a pervasive consumer/entertainment multimedia technology, developers have not attempted to provide business professionals with applications based on DVD or any other multimedia platform. Moreover, most businesses lack the multimedia tools, skills, and time necessary to incorporate multimedia technologies into their business communications. It would be desirable, therefore, to implement a software application that leverages the advanced audio and video capabilities of contemporary multimedia technologies to enable even unskilled users to build visually stimulating business presentations, kiosks, training and marketing materials.

### SUMMARY OF THE INVENTION

The objective identified above is achieved according to the present invention with a product for creating presentations based on “video slides.” A video slide is an object that preferably includes a looping background video, other still and/or motion video, and an appended layer of text. The product enables even a novice user to create a navigable and linked set of video slides. The product enables the user to insert and edit text on a video slide so that, for example, a video slide may have a continuously looping video-based background to which a text overlay is appended.

The product enables a user to edit the linked set of slides by inserting a video slide into the linked set, altering the ordering of the video slides in the linked set, and deleting a video slide from the linked set. Preferably, the product permits the user to take any of these actions using simple menu commands, drag and drop techniques, and other editing functions that would be familiar to users of conventional presentation applications, multimedia authoring applications, and video editing applications. In such cases, the product responds to a user edit by automatically modifying and relinking the set of video-based slides.

In a DVD implementation, for example, the product provides a graphical user interface that enables the user to create a sequence of video slides, where each video slide is preferably a relatively short, looping, DVD-compliant video. Each slide includes navigation elements (e.g., buttons) that enable a presenter to move from slide to slide. Each slide might, for example, include a “next” button, a previous “button,” and a “menu” button, enabling the present to go the next slide, the previous slide, or to a main menu respectively. When a user edits the sequence of slides (e.g., rearranging, deleting, or inserting slides), the program relinks the slides to each other. Those familiar with DVD-based editing will appreciate that it is highly beneficial to provide a facility that performs the relinking automatically because, as the number of video slides increases, the difficulty in managing all of the links increases proportionally. In this manner, the application incorporates elements of presentation applications, video editing applications, multimedia authoring applications, and media storage and retrieval applications to provide a product capable of generating visually captivating, video slide based presentations for business and other audiences.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing system according to an embodiment of the invention;

FIG. 2 is a flow diagram illustrating a method and program product (software) for generating a presentation;

FIG. 3 is a flow diagram illustrating details of a video slide creation block in the flow diagram of FIG. 2 according to one embodiment of the invention;

FIG. 4 is a conceptual illustration of a video slide based presentation according to an embodiment of the present invention;

FIG. 5 is an exemplary user interface, emphasizing the ability to edit video slide objects, for use in creating video slide based presentations according to an embodiment of the invention;

FIG. 6 is another exemplary user interface, emphasizing the ability to edit movie objects, according to the present invention;

FIG. 7 is another exemplary user interface, emphasizing the ability to edit menu objects, according to the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention encompasses a system, method, and software that facilitate the creation of a video slide-based presentation. The software executes on the system to present a user with various user interfaces. Various user interfaces enable the user to create a set of video slide-based objects (video slides) that are linked in a particular sequence. The video slides include navigation elements that enable the user to navigate among the linked set of video slides. The navigation elements may include NEXT, PREVIOUS, and MENU elements enabling the user to retrieve and present the next slide, the previous slide, or a presentation main menu, respectively.

In one embodiment, a video slide includes a relatively short video segment of less than approximately one minute that loops seamlessly and endlessly. The video segment includes a moving background over which text and possibly other graphics are displayed. The text and other graphics are preferably included in the video slide as an overlay to the video-based looping background. A video slide may display its associated navigation elements or, alternatively, the user may elect to hide them from display.

The user interface preferably enables the user to create and edit an individual video slide or a group of video slides using a multi-windowed user interface. In one embodiment, the text elements of the individual slides that form the presentation are displayed, in outline form, within a first user interface window. A second user interface window displays the video slide as it will appear during a presentation (e.g., with a static view of the background video and the overlying text and graphics). In the preferred embodiment, the user may edit the text for a slide using either the first or second windows. For example, after highlighting one of the video slide objects in the first window, typing text within the first window will insert the corresponding text in the highlighted video slide.

In addition, the user interface facilitates easy and error-free rearranging of the video slide objects. The user interface preferably permits the user to drag and drop video slide objects in any desired sequence. The user interface then automatically updates the linking of all affected video slide objects. Automatic re-linking of the video slides in the presentation following the insertion of a new video slide into a presentation, the deletion of an existing slide, or the rearranging of the existing slides, produces significant savings of time and effort that would otherwise be necessary to ensure that the navigation links of each video slide are updated.

Although the invention is not limited to any particular video format or storage format, an embodiment of the invention generates DVD-compatible presentations using MPEG compliant video slides. DVD-compatible embodiments of the invention generate presentations that may be stored on a DVD and played on a conventional DVD player. Alternatively, an image of a presentation may be stored to a hard disk of a computer. The computer may then play the image directly from the hard disk.

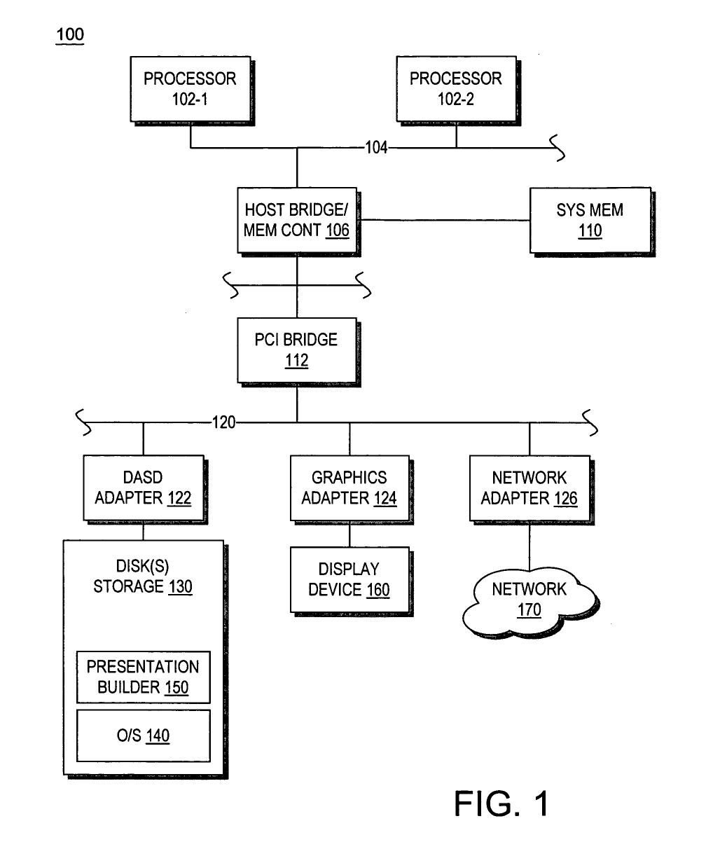

Turning now to the drawings, FIG. 1 is a block diagram of selected elements of an embodiment of a data processing system 100 suitable for creating presentations according to the present invention. In the depicted embodiment, system 100 includes one or more general purpose microprocessors, two of which are shown as processors 102-1 and 102-2 (generically or collectively referred to herein as processor(s) 102). Processors 102 are connected to a shared bus 104 referred to herein as host bus 104. A host bus bridge (host bridge) and memory controller 106 provides an interface between system bus 104 and a system memory 110 thereby enabling processors 102 to access system memory 110. System 100 is referred to as a symmetric multiprocessor system because each processor 102 has equal access to system memory 110 (e.g., the latency for an access to system memory 110 is approximately the same for all processors 102). Other implementations of system 100 include single processor systems and non-uniform memory architecture multiprocessor systems.

System 100 as shown includes a PCI bridge 112 providing an interface between host bridge 106 and a PCI bus 120. PCI (peripheral components interface) is an industry connectivity standard. Other implementations of system 100 may use other connectivity protocols including the Infiniband protocol.

In the depicted configuration, system 100 includes a direct access storage device (DASD) adapter 122, a graphic adapter 124, and a network adapter 126 connected to PCI bus 120. DASD adapter 122 controls disk storage (hard disk) 130. Graphics adapter 124 provides the control for a display device 160 (e.g., a CRT or LCD). Network adapter 126 provides connectivity between system 100 and an external network 170. Network 170 may include a local area network (LAN) and/or a wide area network such as the Internet.

In the depicted embodiment, data processing system 100 includes computer program code stored in its hard disk 130. The computer program code includes an operating system 140 and a presentation builder application 150 according to the present invention. The present invention is not limited to a particular operating system. Accordingly, operating system 140 may be a Windows® family operating system from Microsoft Corporation, a Unix or Unix derivative operating system, a Linux operating system.

The presentation builder application 150 provides the computer code that when executed enables a user to create video-slide based presentations. As such, portions of the invention are implemented as a set or sequence of computer executable code stored on a computer readable medium such as hard disk 130. During times when the code is being executed by a processor 102, portions of the code may be stored in system memory 110 or in one or more cache memories (not illustrated) associated with processor(s) 102.

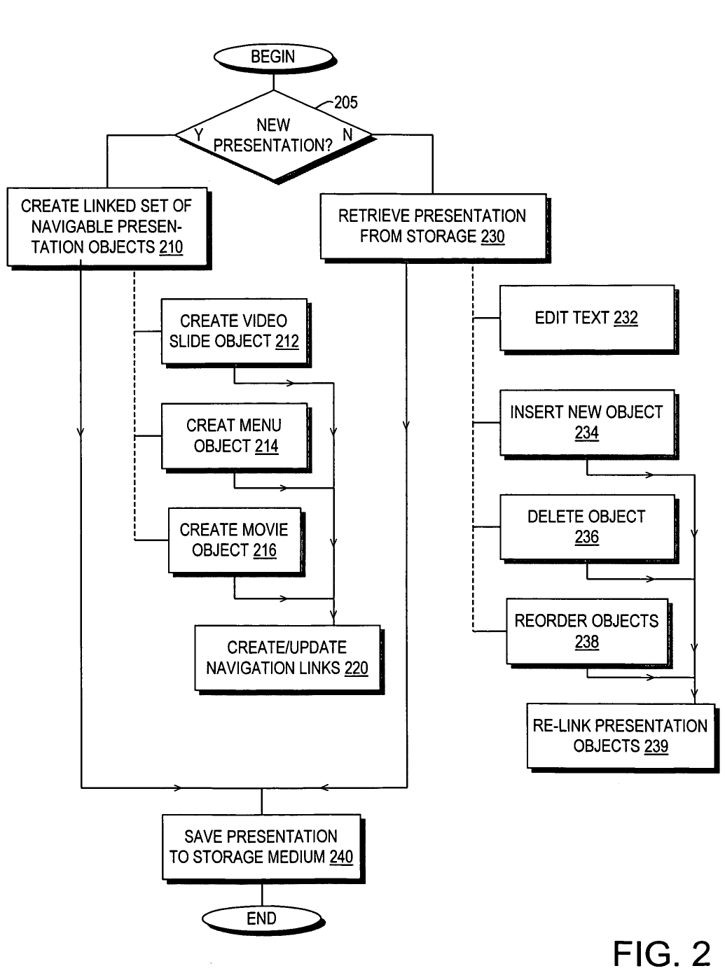

Referring now to FIG. 2, a flow diagram conceptually depicts functionality included in one embodiment of presentation builder application 150. In the depicted embodiment, presentation builder application 150 enables a user to select (block 205) between the creation of a new presentation and the editing of an existing presentation. If a new presentation is selected, the depicted embodiment of presentation builder application 150 enables the user to perform any of three major functions, namely, creating (212) a video slide object, creating (214) a menu object, and creating (216) a movie object.

In one embodiment, video slide objects are likely to comprise the bulk of the objects contained in a presentation. For purposes of this disclosure, a video slide refers to an object that preferably contains a full size looping background video, other still and motion multimedia, and an appended layer of text. A looping video refers to a video that, when played, executes from a beginning point to an ending point and then automatically branches back to the beginning point and begins to execute again. Presentation builder application 150 applies a looping video paradigm into the context of business presentation applications.

Looping video content is especially suitable for use as a background to a presentation slide. Whereas conventional presentation applications present the audience with slides that are generally static and uninteresting, video slides may be used to create slides having dynamic and visually stimulating background content. In one embodiment, for example, the video content of a video slide is MPEG-2 compliant video (or multimedia) content suitable for being played with a wide variety of player devices including DVD players (that support MPEG-2 video content) and other types of viewers or players.

In the preferred embodiment, video slide objects are implemented using seamlessly looping videos. A seamlessly looping video is a video segment in which a transition from the end of the video to the beginning is not readily perceptible to the human eye (e.g., because the scene at the end of the loop is substantially identical to the scene at the beginning of the loop).

Because the transition from end to beginning in a seamlessly looping video is not readily detectable, seamlessly looping videos enable the use of short video slides. In other words, seamlessly looping video can execute for any period of time without conveying any discontinuity to the audience. Because it is generally not known how long will be required to display and discuss each video slide in a video object, it is important to provide video slides that can remain displayed for an extended period of time without discontinuity. On the other hand, because video content is data intensive, it is desirable to constrain the amount of video content in a video slide. By using seamlessly looping video, a video slide can remain displayed indefinitely while only requiring a finite amount of storage. In one embodiment, for example, presentation builder application 150 includes or has access to a library of seamlessly looping video backgrounds where each looping video background is a 30 second video segment. The precise duration of any looping video is an implementation detail, but 30 seconds is considered to be an optimized duration (because it is long enough to prevent the perception of being repetitive and short enough to mask any playback discontinuities attributable to the transition from end to start, but without consuming excessive storage).

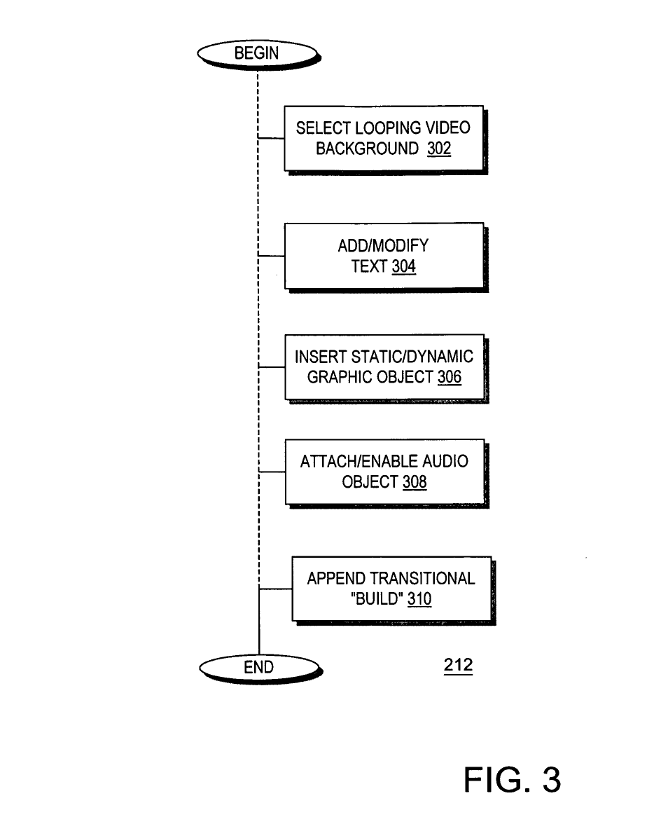

Referring to FIG. 3, a flow diagram depicts selected elements of the process 212 of creating a video slide suitable for use in a video presentation according to the present invention. In the depicted embodiment, the video slide creation process 212 includes selecting (block 302) a looping video background. In the preferred embodiment, the presentation builder application 150 includes an interface that facilitates the user's creation of video-slide-based presentations. Generally, this interface enables the user to select looping video background from a library of video backgrounds.

After selecting a looping video background, the user may enter or modify (block 304) text associated with the video slide. In the preferred implementation, adding text to a video background is achieved by simply typing the text within a window that displays the looping video background (or a static image of the looping video background). In the preferred embodiment, the text is appended to the video background object as an overlay feature that maintains a distinction between the video content and the textual data as opposed to an application that integrates text into the video content so that the two are not separable. Maintaining the text associated with a video slide in this manner greatly facilitates text entry and text modification features.

The use of text overlays is also desirable because various protocols provide native support for text overlays. DVD, for example, supports text overlays in conventional movie applications for things such as subtitling. The presentation builder application 150 leverages this functionality and applies it to the business presentation environment. Regardless of how text is associated with a video slide, however, presentation builder application 150 provides a user friendly interface that facilitates text entry/modification. Details of an embodiment of an exemplary user interface enabling the entry/modification of text are described below.

In some presentations, all or most of the video slides use a single looping video background or a limited number of backgrounds. Rather than create an entire set of video slide objects, each containing a replicated copy of the same looping video background, presentation builder application 150, in conjunction with a viewer application (not depicted), may support the creation of video-slide-based presentations that conserve storage. More specifically, an application (whether it be the presentation builder or a viewer application) enables the user to specify, in an external file, the text desired for each presentation slide. This specification may be made, for example, using an XML file. The viewer application could then import the specified text, in real time, and display the imported text overlying the looping video background. In this manner, replicated copies of the single video background would be avoided thereby saving significant storage requirements.

Returning to FIG. 3, the depicted embodiment of the video slide creation process 212 supports features in addition to the looping video background and the text overlays. Specifically, the depicted embodiment of video slide creation process 212 supports the insertion (block 306) of one or more static or dynamic graphic objects into a video slide. Using this feature, a video slide might contain, in addition to a looping video background and overlay text, a graphic object (e.g., a static or dynamic corporate logo) that enhances the appearance of the video slide and conveys additional information. In one embodiment, the presentation builder interface provides a library of graphic objects that a user may insert into the current video slide using drag and drop editing or the like.

In addition, video slide creation process 212 as depicted in FIG. 3 supports an association (block 308) between an audio object and a video slide. While audio objects are most likely more appropriate for movie objects (described below), it may be desirable to associate an audio track with a video slide. For example, it may be desirable to associate a looping audio object with a looping video so that, when the video slide is displayed, the audio track is heard simultaneously. The preferred embodiment of the user interface enables users to attach audio objects to video slides using an audio library similar to the manner in which graphic objects are attached to video slides.

When an audio object and its corresponding video slide are mismatched in terms of their duration, the presentation builder application 150 may include a feature that “locates” the audio object within the video slide. In one implementation, an audio object that is shorter in duration that a looping video is “centered” within the looping video time window so that, for example, a ten second audio object inserted into a thirty second looping video would play (be heard) during the middle ten seconds of the video (seconds 10 to 20). If the length of an audio object exceeds the length of a video slide to which the audio object is attached, the audio object will begin to execute at the beginning of the video slide and terminate at the end of the video slide loop.

Video slide creation process 212 as depicted in FIG. 3 also supports the inclusion (block 310) of a “build” object. A build object is a video sequence that provides a visual transition to the beginning of a video slide with which the build object is associated. A build object might cause the text portion of a video slide to “fly” or fade into the video slide creating a more dynamic and visually captivating video slide. In the preferred implementation, build objects and their associated video slides are not only played in a chronological order, but they are also stored in adjacent or contiguous storage locations. Using contiguous memory beneficially reduces potential visual discontinuities that might otherwise occur in the transition from a build to a video slide. Discontinuities can occur when the build object is stored in a portion of the storage medium that is distant from the storage medium portion in which the corresponding video slide is stored. Such discontinuities are attributable, in part, to the long latency associated with retrieving data from persistent storage.

Returning now to FIG. 2, the creation of a linked set of navigable presentation objects (block 210) also includes a block for creating (block 214) a menu object, and for creating (block 216) a movie object. A menu object may include a looping video background and other elements similar to the video slide object. In one implementation, however, a menu object does not include explicit navigation links a video slide would have (e.g., the NEXT, LAST, and PREVIOUS buttons). In one implementation, a menu object is especially useful when multiple presentations are stored on the storage medium. In such cases, the menu object provides a link to the first slide of each presentation stored on the medium.

A movie object, as its name suggests, is a video that plays sequentially from beginning to end a single time, after which the presentation proceeds to the next video slide or to another movie object. Whereas video slides are preferably implemented with fixed length looping video backgrounds over which text is appended, movie objects are variable length objects that would not typically include text overlays. Whereas video slides and, more specifically, the text content of video slides is typically discussed or highlighted by the person who is doing the presentation, movie objects are typically stand alone objects that include an audio track and do not need the assistance of a presenter.

Presentation builder application 150 facilitates the construction of a presentation by including functionality to maintain and update navigation links that bind the individual video slides, movie objects, and menu objects into a coherent and navigable whole. When a new object is created in blocks 212, 214, or 216, presentation builder application 150 creates or updates (block 220) navigation links associated with the presentation. When a new video slide is inserted into a presentation, for example, a new set of links is created to link the new slide to its previous slide and to the appropriate menu object. In addition, the next slide link of the previously created video slide or movie object is also created or updated to link the new slide with the existing slides. After completing the creation or editing of the presentation objects, the presentation is stored (block 240) to a storage medium, which may a hard disk, an optical disk such as a DVD, or another suitable persistent storage medium.

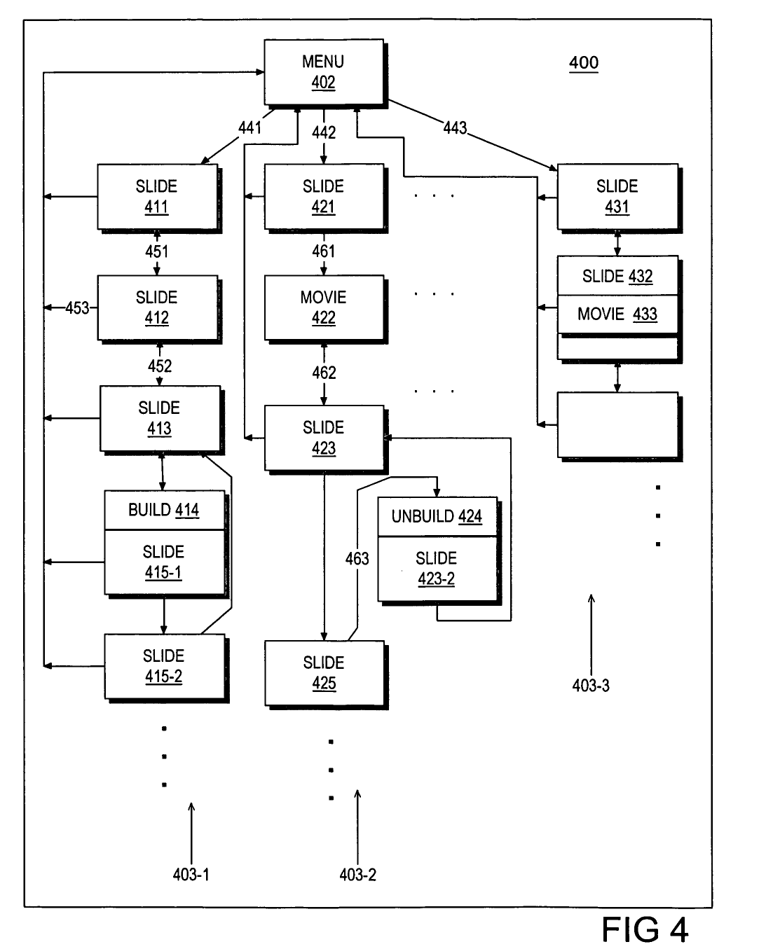

Referring to FIG. 4, a conceptual block diagram of a presentation 400 according to an embodiment of the present invention is depicted. In the depicted embodiment, presentation 400 includes a menu object 402 that includes links to one of three presentations 403-1, 403-2, and 403-3. A first link 441 links menu object 402 to the first slide in presentation 403-1, a second link 442 links the menu object 402 to the second presentation 403-2, and a third link 443 links menu object 402 to the first slide of third presentation 403-3. The links 441-443 between menu object 402 and the presentations 403 are implemented as hyperlinked text in menu object 402. Link 441, for example, might be implemented as a text hyperlink indicating the name of first presentation 403-1, while link 442 might be implemented as a text hyperlink indicating the name of second presentation 403-2, and so forth. In this implementation, menu object 402 might appear as a set of titles to the presentations accessible from menu object 402, where each title is a hyperlink that links the menu object to the corresponding presentation.

In the embodiment depicted in FIG. 4, presentation 400 includes a set of presentation objects 411 through 431 where each object is either a video slide, a movie object, or another menu object (although the embodiment depicted in FIG. 4 includes only the single menu 402). Each presentation object 411 through 431 is shown as being linked to three other presentation objects, namely, a NEXT presentation object, a PREVIOUS presentation object, and the MENU object. For the special case of slides 411, 421, and 431, which are the first presentation objects in their respective presentations 403-1 through 403-3, there is no previous presentation object and the previous object link leads back to menu object 402. Similarly, for any presentation object that is the last slide in its respective presentation, there is no next presentation object. In one embodiment, the next object link for any of these objects links either to the first presentation object in the presentation or to the menu object 402.

For a slide such as 412, which is neither the last slide in its presentation nor the first slide, the previous link (reference numeral 451), when activated, causes the presentation to jump to presentation object 411. The next slide link 452, when activated, causes the presentation to jump to the presentation object 413. The menu object link 453, when activated, causes the presentation to jump back to main menu 402.

In the depicted example, all of the presentation objects in first presentation 403-1 are video slide objects that link to previous, next, and menu objects. As described above, each video slide object includes a looping video background and additional objects that may include an appended text layer, and static or moving graphical objects. In the depicted example, second presentation 403-2 includes a movie object 422 positioned between video slide 421 and video slide 423. In this example, movie object 422 does not include a link to the previous video slide object 421 or to menu object 402. Instead, when the next object link 461 of video slide 421 is activated, movie object 422 plays from beginning to end after which the presentation jumps to video slide 463. In other implementations, movie object 422 may include the same NEXT, PREVIOUS, and MENU slides of a video slide such as video slide 411.

The illustration of presentation 400 presented in FIG. 4 emphasizes the potentially large number of links among the various presentation objects. Moreover, one can readily appreciate that modifications of a presentation such as 400 may be required from time to time. Modifications to presentation 400 may include inserting new presentation objects into the presentation, deleting existing presentations from the presentation, and rearranging and modifying the existing presentation objects. Any of these modifications could affect a potentially large number of links in the presentation. Presentation builder application 150 according to the present invention simplifies the process of modifying or editing an existing presentation by automatically altering the links within the presentation following each modification so that all presentation objects are correctly linked without user interaction.

FIG. 4 also illustrates the concepts of a “build” and an “unbuild” that are associated with a video slide. A build is a transitional video sequence that provides a visual introduction to the corresponding video slide. As indicated previously, a build may produce effects such as text fly in, fade in, and so forth.

Presentation 400 as depicted in FIG. 4 includes a build 414 that is integrally tied to video slide 415-1. Specifically, the combination of build 414 and video slide 415-1 comprises a single presentation object in the preferred embodiment of presentation builder application 150. Presentation builder application 150 stores build 414 in storage that is contiguous with or in close proximity to the storage location where video slide 415-1 is stored so that discontinuities are minimized during playback when a presentation system (a DVD player for example) plays build 414 and video slide 415-1 in succession.

In the depicted embodiment, build 414 and its corresponding slide 415-1 are played once before the presentation jumps to the next slide 415-2. In the preferred implementation, video slide 415-2 is a looping copy of video slide 415-1 (i.e., the content of video slides 415-1 and 415-2 is the same, but video slide 415-2 is configured to loop endlessly while slide 415-1 is configured to execute once).

Presentation 400 as depicted in FIG. 4 also includes an unbuild object 424. Unbuild object 424 is a transitional sequence from a video slide to the previous video slide. As depicted in FIG. 4, for example, unbuild object 424 is a sequence that transitions the presentation from video slide 425 to the previous video slide 423. When the presentation is displaying video slide 425 and the presenter activates the previous slide link 463, the presentation executes unbuild 424 before returning to the previous slide 423. Unbuild object 424 is appended to a copy 423-2 of the previous video slide 423. The copy 423-2 is configured to execute a single time before returning to the previous slide 423, which is a looping video. In this manner, presentation 400 implements a transition from a presentation object to the previous presentation object.

Presentation 400 also exhibits the concept of an embedded movie object 433. In the depicted embodiment, a movie object 433 is embedded within a video slide 432. Video slide 432 includes next, previous, and menu navigation buttons like the conventional video slide objects. Unlike conventional video slides, however, embedded movie video slide 432 includes an embedded movie 433. When video slide 432 is played, it executes the embedded moving sequence 433. Upon completion of the embedded movie, the video slide 432 loops back to itself. When the embedded movie 433 is queued for execution during the second loop of video slide 432, the presenter can activate the next button to transition to the next presentation object. Linking between the video slide 432 and movie 433 is entirely transparent to the user and video slide 432 is handled like all other video slide objects externally.

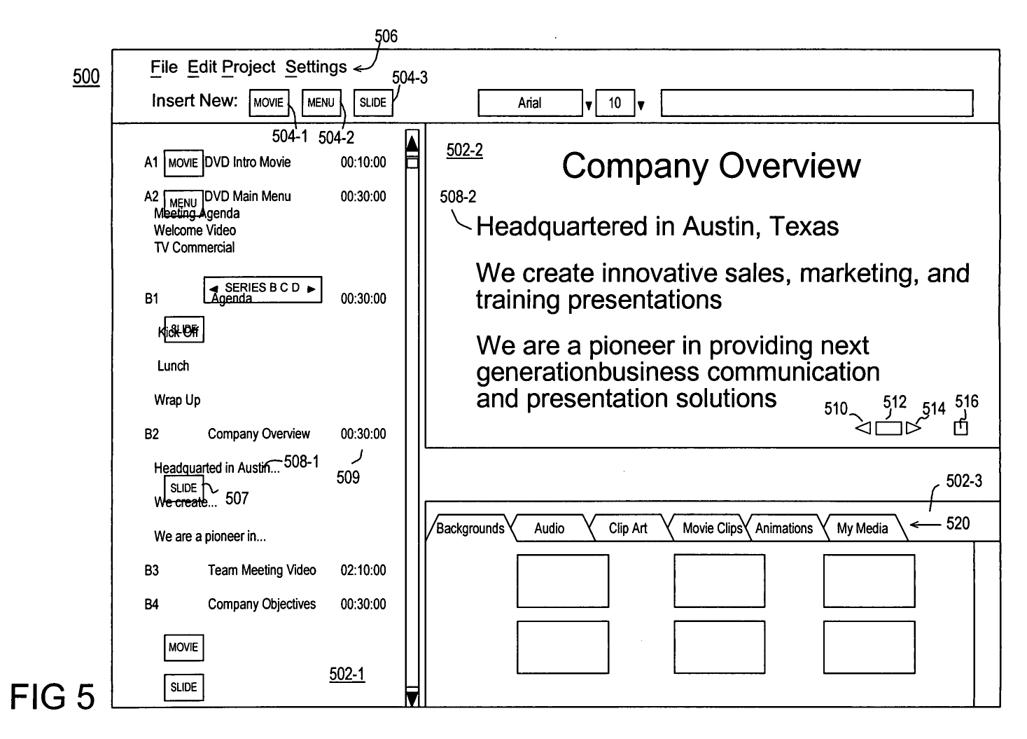

In some embodiments suitable for use with video slides such as video slide 432 and movie objects such as movie object 422 and embedded movie object 433, an additional navigation button (in addition to the next, previous, and menu buttons) is included. Specifically, a “play” button may be included in this type of object. The play button (depicted in FIG. 5) launches a movie, which then returns to that slide after it has played.

Returning to FIG. 2, presentation builder application 150 according to the depicted embodiment includes functionality for modifying or editing existing presentations. In the depicted embodiment, presentation builder application 150 is configured to retrieve (block 230) an existing presentation from storage. Following retrieval of an existing presentation, presentation builder application 150 enables the user to perform a number of modification and/or editing steps to change the presentation.

The modification or editing steps supported in the depicted implementation of presentation builder application 150 include text editing (block 232), the insertion (block 234) of new presentation objects, the deletion (block 236) of existing presentation objects, and the reordering (block 238) of existing presentation objects. Editing text of an existing presentation in block 232 does not require alteration of a presentation's existing links (assuming that the text editing does not result in the creation of a new presentation object).

In contrast, the editing tasks of inserting new presentation objects, deleting existing objects, and rearranging existing objects, require a relinking (block 239) procedure. Presentation builder application 150 facilitates the maintenance of links between a number of different video-based presentation objects. In one embodiment, edit modifications that affect the number or order of existing presentation objects invoke relinking procedure 239 when the editing is completed so that links may be updated without delay. In a specific implementation such as a DVD implementation, the link objects may be restricted to specific regions of the storage medium and may even be restricted in number and amount of time required for each one to execute.

Thus, in a preferred implementation of the invention, each video slide object is at least linked (see FIG. 4 and accompanying description) to its previous presentation object, the next presentation object, and the main menu object. The complexity of linking the navigation structure is hidden from the user, who edits slides in a text-based outline (see FIG. 5 through FIG. 7 below) or in tree format. Whenever the user changes the location of a slide either through the outline or a “tree view” available in the editor, the next and previous slide links must be changed. Presentation builder application 150 handles this maintenance without user intervention or notification. The user simply drags and drops a video slide or other object to the new location and the application will re-link the presentation objects. The presentation object's position in the outline and tree editor reflects the slide's position when it is burned to a DVD or an image is made. In typical authoring applications, one small change to a presentation could have a ripple effect requiring modification to the links and buttons of many slides. This effect increases errors such as incorrectly linked slides or dead buttons. Dead buttons can be particularly detrimental. Whenever a user activates a dead button, the presentation may jump to a black screen and “hang,” thereby possibly requiring restarting the presentation system.

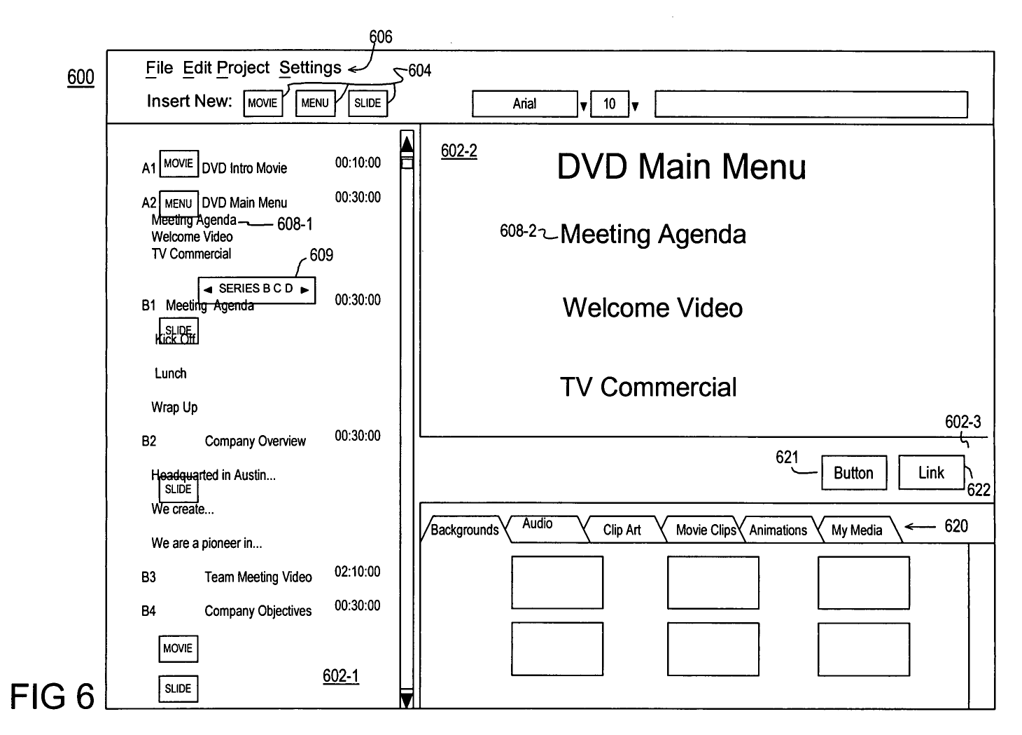

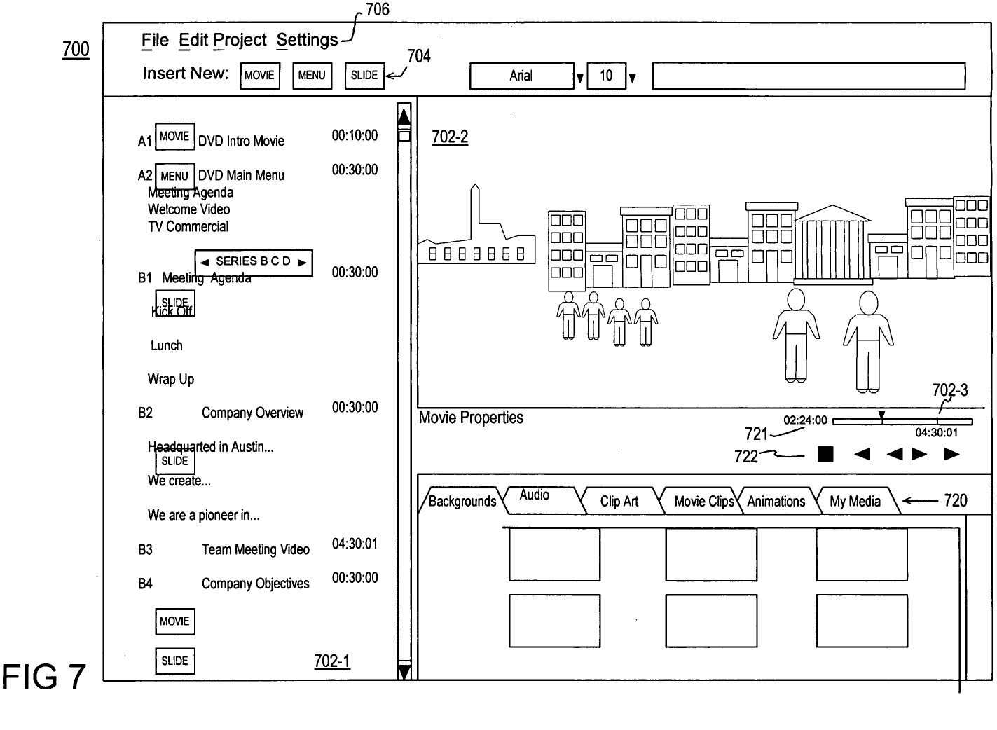

The present invention encompasses graphic user interfaces (GUI's) that facilitate the creation of the presentations described above. Implementations of GUI's for creating each type of presentation object are depicted in FIG. 5, FIG. 6, and FIG. 7.

Turning now to FIG. 5, a GUI 500 suitable for creating video slide objects for use in a presentation such as the presentation 400 depicted in FIG. 4, is shown. In the depicted embodiment, GUI 500 includes multiple windows 502-1 through 502-3. A first window 502-1 is referred to as the outline window, a second window 502-2 is referred to as the editing window, and a third window 502-3 is referred to as the library window. Other implementations may have more or fewer windows.

GUI 500 and presentation builder application 150 support outline-based presentation authoring. Outline based authoring refers to the use of a text-based outline to control placement of text on a storage media and the placement of the media within a fixed or hard disk. In one implementation, the presentation builder application 150 presents a user with GUI 500, which includes outline window 502-1, editor window 502-2, and the library window 502-3. Outline window 502-1 facilitates the inclusion of text on video slide objects (and menu objects) while the editor window provides the user with a snapshot of the currently active object (e.g., the current video slide, movie, or menu object being edited). Bullets and text typed in outline window 502-1 appear in the editor window as bullets on the slide. The opposite is also true text typed in editor window 502-2 appears in the outline window 502-1. In this manner, text is added to video slide objects and menu objects from either of two simultaneously displayed windows. For example, the text “Headquartered in Austin” is represented in outline window 502-1 by reference numeral 508-1 and in editor window 502-2 by reference numeral 508-2. This text may be modified or deleted from either of the two windows 502-1 or 502-2. Text typed in the outline or editor windows is also checked for spelling and grammar.

In conventional DVD and other authoring applications, each media object is a movie, and the movie is typically how the authoring is organized. For example, in most authoring applications, the user must drag each movie into the editor screen, place the buttons on separately and link the movie to each other object in turn. This method was designed for standard movies. It is complex, inefficient, and prone to error when used to create video slide based presentations.

Outline based authoring is specifically designed to facilitate the creation of DVD-based presentations. Video slide objects, menu objects, and movie objects are all treated as separate objects. It is text driven, meaning that when users create new slides, they simply put the text they would like to see on the slide into the outline, and place the slides within the outline in the order they would like. Navigation buttons and placement on disc are all automatically generated and maintained by the presentation application. Errors such as incorrect links will be vastly reduced. This functionality offers a paradigm similar to current slideware based applications, so that users may author and create a DVD in nearly the same way they've been using to create a slideware based presentation.

In one embodiment, the typed text associated with any presentation object is appended to the presentation object as an overlay to maintain a distinction between the text and motion video background. In a DVD implementation, for example, the DVD protocol supports the uses of video titles for purposes such as subtitling. Presentation builder application 150 leverages this native functionality to provide easily edited text support for video-based presentation slides.

In the depicted embodiment, outline window 502-1 displays text associated with not only the currently active presentation object (the presentation object that is visible in editor window 502-2), but also text associated with other presentation objects. As seen in FIG. 5, for example, the currently active presentation object visible in editor window 502-2 is represented as presentation object “B2” in outline window 502-1. Also visible in outline window 502-1 are the text elements of other presentation objects including presentation objects “A1”, “A2”, “B1”, “B3”, and “B4.” In the nomenclature depicted in FIG. 5, presentation objects are designated by a letter indicating the specific presentation and a numeral indicating the specific presentation object within the presentation. Thus, presentation object “B2” is the second presentation object in presentation “B.”

Outline window 502-1 also includes an identifying element 507 that indicates the type of presentation object. Presentation object B2, for example, is a video slide as indicated in outline window 502-1 by identifying element 507. Outline window 502-1 as shown in the GUI 500 of FIG. 5 also includes a time indicator 509 that indicates the amount of time or length of the presentation object. For video slide objects and menu objects, the time indicator 509 indicates the amount of time associated with the looping background video. In the example shown, all video slide and menu objects have the same length (30 seconds in this example). Movie objects, on the other hand, have durations that are determined by the content of the movie.

Editor window 502-2 displays the currently active presentation object or a snapshot of the currently active presentation object. Editor window 502-2 thus enables the user to visualize the size, font, color, and placement of the typed text. In addition, editor window 502-2 displays the currently selected background video (or a snapshot of the currently selected background) for video slide objects and menu objects. As shown in editor window 502-2, video slide objects according to one embodiment of the invention include a set of three standard navigation buttons or elements 510, 512, and 514. Navigation element 510 is a previous or back button that, when activated during playback of a presentation, causes the presentation to jump to the beginning of the previous presentation object. As an example, if back button 510 were activated while presentation object B2 was playing, the presentation would jump to the beginning of presentation object B1. Menu button 512 transitions the presentation to the main menu from the currently displayed presentation object and next button 514 causes the presentation to skip to the next presentation object.

In the preferred embodiment, navigation buttons 510, 512, and 514 may be dragged and dropped anywhere within editor window 502-2. In some embodiments, the three navigation buttons are linked to each other such that a user cannot move the buttons independently of one another. In some embodiments, a user can make navigation buttons 510 through 514 invisible during playback of a presentation to reduce any confusion caused by the presence of navigation buttons in a video slide or other presentation object.

Navigation buttons 510 through 514 allow a video-based presentation to be presenter led. Users (i.e., presenters) may navigate to the next presentation object by making the next object button 514 the active button and pressing an “activate” button on their remote control, keyboard, or mouse. In one embodiment, the next button is selected as the button that is automatically active when the slide is active. This default preference facilitates ease of navigation through the slides by enabling the user to move to the next object by pressing only the activate button.

The depicted embodiment of GUI 500 also displays a “play” button 516. Play button 516 is useful in conjunction with movie objects including movie objects that are embedded within a video slide. Activating play button 516 causes a corresponding movie object to play and, upon completion of the movie, return to the existing slide.

GUI 500 as depicted in FIG. 5 also includes a menu bar 506 and a set of insert buttons 504-1 through 504-3. Menu bar 506 provides easy access to various application functions including file commands (e.g., open, save, save to, etc.), editing commands, project commands, and settings commands. The specific features and arrangement of menu bar 506 is implementation specific. Insert buttons 504-1 through 504-3 enable a user to insert a new menu, movie, or video slide object at any point in the presentation.

The library window 502-3 of GUI 500 provides various support features and functions that facilitate the creation of presentation objects. As depicted in FIG. 5, library window 502-3 includes a set of tabbed libraries 520 including a background library, an audio library, a clip art library, a movie clip library, an animations library, and a user-customizable library indicated as “My Media.” Within each library tab 520, presentation builder application 150 provides the user with the ability to select from among multiple choices for a background to a video slide or menu object, clip art to be appended to a video slide or menu object, and so forth. The preferred embodiment of GUI 500 includes drag and drop support that enable the user to drag elements from library window 502-3 into editor window 502-2. In this manner, for example, changing the background associated with a video slide or menu background would require the user only to select the desired background from the library and drag the selected background into the editor window, where presentation builder application 150 will insert the current background.

Referring now to FIG. 6, a GUI 600 suitable for use with a menu object is shown. In the depicted embodiment, GUI 600 maintains much of the same look and feel as the video slide GUI 500 of FIG. 5. Thus, GUI 600 includes an outline window 602-1, an editor window 602-2, and a library window 602-3, which are all analogous to windows 502-1 through 502-3 described above with respect to FIG. 5. For menu objects, the text editing functionality of GUI 600 is substantially identical to the text editing functionality of GUI 500. A user may edit text or bulleted items in editor window 602-2 or outline window 602-2. Thus, the “Meeting Agenda” bullet 608-2 in editor window 602-2 corresponds to the “Meeting Agenda” line item 608-1 in outline window 602-1. The library window 602-3 of GUI 600 supports substantially the same options as the library in window 502-3 of GUI 500.

One distinction between menu objects and video slide objects in the preferred embodiment is the use of navigation buttons for video slide objects and hyperlink-like text entries for menu objects. The menu object depicted in editor window 602-2 of GUI 600 includes a set of three text items. Each text item identifies and is associated with a corresponding presentation. A user accesses any of the three presentations by selecting one of the text entries in the menu object and asserting the activate button.

If a menu object is edited to include a new text entry, a corresponding presentation is associated with the next text line. The menu linking is displayed in the outline window 602-1 by the menu linking element 609. The depicted example of menu linking element 609 includes selection buttons for three presentations (labeled presentations “B”, “C”, and “D”). The link and button elements 621 and 622 in editor window 602-2 enable the user to include new presentations into an existing presentation framework. Like GUI 500, the menu object GUI 600 includes a function toolbar 606, tabbed libraries 620, and a set of insert buttons 604 enabling the user to insert a new menu, movie, or video slide object at any point in the presentation.

Referring to FIG. 7, a GUI 700 suitable for use with movie objects of the present invention is shown. GUI 700 maintains the same multiple window look and feel as GUI 500 and GUI 600. Thus, GUI 700 includes an outline window 702-1, an editor window 702-2, and a library window 702-3.

In the case of movie objects, editor window 702-2 displays the corresponding movie or a static snapshot of the movie. While the functions in library window 702-3 resemble the library window functions for GUI 500 and GUI 600, many of the functions are not generally applicable to movie objects. Movie objects, for example, generally incorporate a corresponding sound track that might potentially render an audio clip library unnecessary. Editor window 702-2 does, however, include movie-specific function buttons 721 and 722. In the depicted embodiment, these function buttons enable the user to start, stop, reverse, and forward the corresponding movie. In addition, the depicted implementation of GUI 700 includes a visible timing meter that indicates the current position within the movie object and the total length of the movie object. Like GUI's 500 and 600, GUI 700 includes function toolbar 706, insert buttons 704, and tabbed libraries 720.

It will be apparent to those skilled in the art having the benefit of this disclosure that the present invention contemplates a system, method, and software for creating video-based presentations. It is understood that the form of the invention shown and described in the detailed description and the drawings are to be taken merely as presently preferred examples. It is intended that the following claims be interpreted broadly to embrace all the variations of the preferred embodiments disclosed.

1. A computer program product comprising computer executable instructions, stored on a computer readable medium, for creating a presentation, comprising:
computer code means for enabling a user to create a navigable and linked set of video slides, wherein the video slides comprise looping videos;
computer code means for enabling the user to include text in a video slide by appending a text overlay to a video slide; and
computer code means for enabling a user edit of the linked set, wherein the user edit is selected from the group consisting of inserting a video slide into the linked set, altering an ordering of the video slides in the linked set, and deleting a video slide from the linked set; and
computer code means, responsive to said user edit, for relinking the set of video slides to reflect the user edit.

2. The computer program product of claim 1, wherein the looping videos comprise short looping videos having a duration of less than approximately 1 minute.

3. The computer program product of claim 1, wherein the looping videos comprise seamless looping videos wherein a viewer is unable to determine a transition from the end of a looping video to the beginning of the looping video.

4. The computer program product of claim 1, further comprising computer code means for enabling the user to edit the text overlay and thereby edit the text included in the video slide.

5. The computer program product of claim 1, further comprising computer code means for enabling the user to include a movie in the linked set of video slides, wherein the movie comprises a sequential and non-looping video sequence.

6. The computer program product of claim 1, further comprising computer code means for enabling the user to include a motion object in a video slide.

7. The computer program product of claim 1, further comprising computer code means for storing the linked set of video slides to a storage device selected from a hard disk and an optical medium.

8. The computer program product of claim 1, wherein the computer code means for enabling a user to create video slides includes computer code means for providing a user interface having a first window in which the set of video slides is represented as an outline and a second window in which the set of video slides is represented as a snapshot of the video slide.

9. The computer program product of claim 8, wherein the computer code means for providing the user interface includes computer code means for enabling the user to alter an ordering of the video slides by dragging and dropping a text object in the first window.

10. The computer program product of claim 8, wherein the computer code means for providing the user interface includes computer code means for enabling the user to add text to a text object within the first window by editing text displayed in the second window.

11. A data processing system for creating presentations, comprising:
at least one processor and a system memory accessible to the processor;
a presentation application stored in a storage device accessible to the processor, wherein the presentation application comprises:
processor executable instructions for creating a presentation, wherein the presentation includes a set of linked presentation objects, wherein the presentation objects include a video slide object having a looping video background and text overlaying the looping video background;
processor executable instructions for editing the presentation by altering an ordering of the presentation objects in the presentation; and
processor executable instructions, responsive to said altering of the ordering, for maintaining and updating a linking among the presentation objects.

12. The system of claim 11, wherein the processor executable instructions for creating the presentation include instructions for presenting a user with a graphical user interface including a first window in which an outline of the presentation is presented and a second window in which a snapshot of a selected presentation object is depicted.

13. The system of claim 12, wherein the processor executable instructions enable a user to perform text editing of the selected presentation object using either the first window or the second window.

14. The system of claim 11, wherein the presentation objects include a menu object, wherein each of the other presentation objects is linked to the menu object.

15. The system of claim 14, wherein the presentation objects include a set of navigation buttons including a next button configured to cause the presentation to jump to the next presentation object, a previous button configured to cause the presentation to jump to the previous presentation object, and a menu button configured to cause the presentation to jump to the menu object.

16. A computer program product comprising computer executable instructions, stored on a computer readable medium, for creating a presentation, comprising:
computer code means for enabling a user to create a set of presentation objects, wherein the presentation objects are linked to at least one other presentation object;
computer code means for editing the set of presentation objects by altering an ordering of the presentation objects and wherein, responsive to said editing, relinking the presentation objects to reflect the editing;
wherein the presentation objects include video slide objects comprising DVD compatible looping video backgrounds and a text overlay;
wherein the video slide objects include navigation buttons including next, previous, and menu navigation buttons, wherein the navigation buttons enable a presenter of the presentation to jump from a first selected presentation object to a second presentation object.

17. The computer program product of claim 16, wherein the computer code means for creating the presentation includes computer code means for providing a user interface for creating the presentation objects, wherein the user interface includes an outline window in which text associated with a presentation object is shown in an outline format and wherein the user interface further includes an editor window in which a snapshot of the presentation is depicted.

18. The computer program product of claim 16, wherein at least one of the presentation objects includes a build object, wherein the build object provides a visual transition into a video slide object with which the build object is associated.

19. The computer program product of claim 16, further comprising computer code means for storing an image of the presentation to a storage medium, wherein the image is suitable for stand alone execution.

20. The computer program product of claim 16, wherein said editing is selected from the group of actions consisting of rearranging the order of the presentation objects, inserting a new presentation object, and deleting an existing presentation object.
